(19) United States
(12) Patent Application Publication
(10) Pub. No.: US 2008/0060877 A1
(43) Pub. Date: Mar. 13, 2008

(54) Oil Supply Device

(76) Inventor: Harald Klose, Brandenburg/Havel (DE)

Correspondence Address: DAVIS BUJOLD & Daniels, P.L.L.C., 112 PLEASANT STREET, CONCORD, NH, 03301, US

(21) Appl. No.: 11/631,232

(22) PCT Filed: Jun. 9, 2005
(86) PCT No.: PCT/EP05/06176

§ 371 Date: Dec. 29, 2006

(30) Foreign Application Priority Data
Jun. 30, 2004 (DE) 10 2004 031 470.5

(51) Int. Cl. F16H 57/04

(52) U.S. Cl. 184/6.12; 74/467

(57) ABSTRACT

An oil supply device for automotive transmissions (2) with gear wheels arranged on shafts, with bearings, in which gear wheels and shafts are pivotably positioned, and with synchronizer mechanisms (10) which can be moved in the desired direction by operating a lever with control rods and shift-forks and a shaft (4) featuring an axially central drill hole (6) and at least one transverse drill hole (8) for oil supply that features drill holes (14) in a synchronizer body (12) of the synchronizer mechanism (10) as well as a holding plate with a sickle-shaped recess (18).

This application is a national stage completion of PCT/EP 2005/006176 filed Jun. 9, 2005 which claims priority from German Application Serial No. 10 2004 031 470.5 filed Jun. 30, 2004.

### FIELD OF THE INVENTION

The invention concerns an oil supply device.

### BACKGROUND OF THE INVENTION

The lubrication of gearings, bearings and loose wheel bearings positioned on and in shafts is particularly important due to the complex design of automotive transmissions and particularly in manual transmissions. On one hand the gears and bearings have to be sufficiently lubricated, but on the other hand, as little oil as possible should be used in order to guarantee a low drag torque for good shiftability, which is particularly important for ease of shifting with manual transmissions. Oil temperatures should also be moderate, and the oil supply for reverse gear, as well as cold-shifting ability, should be guaranteed. In order to solve the problems connected with this, different types of oil pumps, hollowed shafts and oil lines are used, or oil guide plates, oil drill holes and/or high levels of oil are used. When the gear wheels dip into the oil, it is randomly distributed in the transmission depending on engine speed, gear, and operating state of the vehicle. With pinion gear assembly, the oil in the oil pan is conveyed in the direction prescribed by the pinion gear, so that there are different levels of oil accumulation in the oil pan.

A lubricating-oil system for a transmission system is known from DE 32 38 790 C1, in which a centrifugal pump is used, which directs the oil outward in a radial direction through radially positioned apertures into bypass channels. The oil subsequently passes through a ring groove into a hollowed drive shaft. Even though this system guarantees effective distribution of lubrication oil, it has the disadvantage that the required centrifugal-force pump requires installation space that is not always available as well as a large amount of sealant.

In addition, an oil lubrication system for automotive transmissions is known from DE 195 01 799 C2 which comprises a ring-shaped chamber, into which lube oil and cooling oil are fed, with a rotating drive shaft and a conveying element for the lubricating and cooling oil, in which at least one offset lubricating oil drill hole is placed in the rotating drive shaft and in which the conveying element comprises a catch and guide plate, which is fixedly connected to the transmission housing and takes up most of the cross sectional area of the chamber and is shaped in such a way that the oil conveyed by the rotating drive shaft accumulates at the catch and guide plate due to pressure, and the lubrication and cooling oil is forced through the pinion-offset lubrication-oil drill hole. This solution also disadvantageously requires a large amount of sealant, particularly between the drive shaft and the inside of the transmission housing.

Another oil supply device for supplying lubricating and cooling oil from a housing to a rotating shaft is known from DE 39 27 775 C2. Here two sealing rings are required on the shaft, which are arranged at an axial distance from each other and where sealing areas form between the sealing rings and two sealing surfaces in the housing, which are essentially radially arranged at an axial distance from each other. The sealing rings are held against the sealing surfaces by the primary tension of the oil pressure present between the sealing rings. Here as well, a great deal of sealant is required, which results in high manufacturing and assembly costs.

DE 196 02 041 A1 discloses a shift-fork for a change-speed gearbox featuring a device for feeding splash oil to the synchronizer device, which is actuated with the shift-fork. This is intended solely for avoiding excessive load on the synchronization mechanism by providing the mechanism with an application flow that supplies the synchronizer mechanism with additional splash oil when synchronization begins. This device for feeding splash oil is not practical for better lubrication of a plurality of components in an automotive transmission.

Alternative lubrication concepts to conventional oil-pan or splash lubrication in conventional transmissions are required particularly due to the higher output of automobile motors, which leads to an increase in the thermal power loss in transmissions, which in turn leads to a rise in the heat given off by the housing. The aerodynamic optimization of vehicles and the metal housing of the underbody also increasingly prevent heat emission through the body.

The object of the invention is to disclose an oil supply device for an automotive transmission, particularly a manual transmission, which will improve the lubrication of components and guarantee sufficient lubrication of the components even at very high engine speeds.

### SUMMARY OF THE INVENTION

The oil reaches a synchronizer mechanism through an axially central drill hole in a shaft of the transmission and transverse drill holes. The volume between the synchronizer mechanism and the bearing is reduced when the oil flows in the direction of rotation, during rotation, by placing drill holes in a synchronizer body of the synchronizer mechanism in combination with a crescent-shaped recess in a holding plate of one of the shaft bearings. Some of the oil is fed to the components to be lubricated, for example bearing points, through drill holes in the shaft and synchronizer body. Excess oil can escape in a radial direction between the synchronizer mechanism and bearing. In order to reduce this oil loss, the synchronizer body must be enclosed by a plate, axially on the side facing away from the bearing. The oil reserve in the closed shaft can be used for lubrication of bearing points. For this purpose, additional radial drill holes are placed in the bearing surfaces of the gear bearings. These measures produce obvious improvement in the lubrication of the components in the transmission, even at very high engine speeds.

### BRIEF DESCRIPTION OF THE DRAWINGS

The invention will now be described, by way of example, with reference to the accompanying drawings in which:

FIG. 1 shows a partial cross-sectional view of a transmission with the oil supply device according to the invention, and

FIG. 2 shows a top view of the transmission shown in FIG. 1.

### DETAILED DESCRIPTION OF THE INVENTION

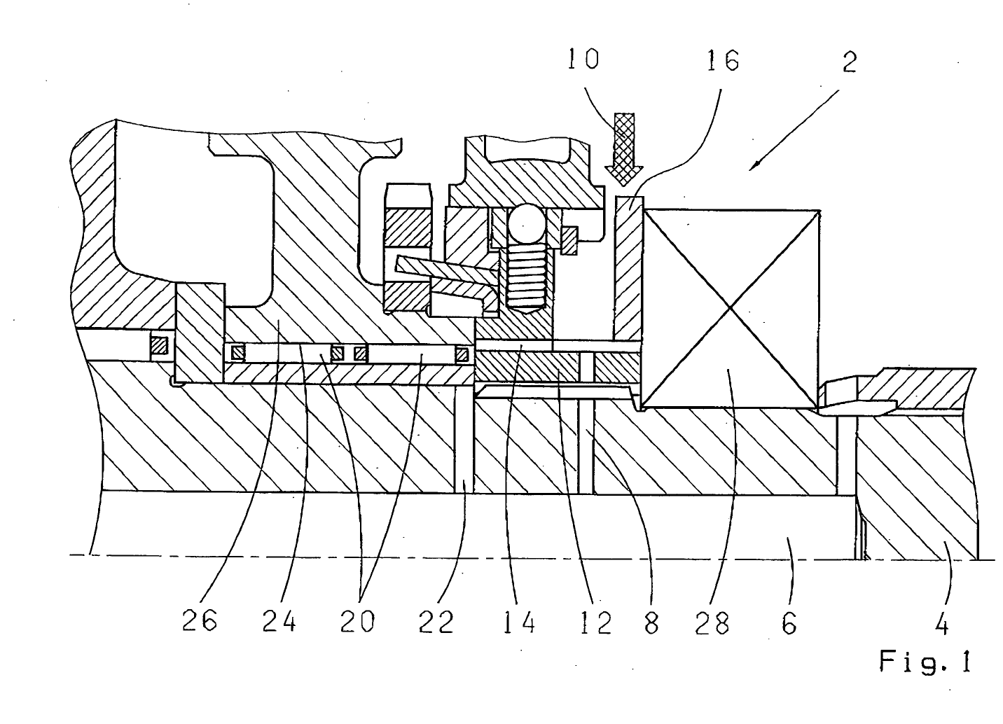

FIG. 1 shows a partial cross section of a transmission according to the invention 2 with a shaft 4 featuring an axially central drill hole 6. Oil reaches a synchronizer mechanism 10 through transverse drill holes 8. A synchronizer body 12 of the synchronizer mechanism 10 features a drill hole 14 which is connected to a holding plate 16 featuring a crescent-shaped recess 18, which ensures that the volume between the synchronizer mechanism 10 and the bearing 28 is reduced when the oil flows in the direction of rotation during rotation. Some of the oil is fed to the components to be lubricated, here for example bearing 20, through the central drill hole 6 in shaft 4, the transverse drill hole 8 and the drill hole 14 in the synchronizer body 12. Excess oil can escape between the synchronizer mechanism 10 and bearing 20 in a radial direction. A bearing surface of the bearing 24 of the gear wheel 26 is supplied with additional oil through a transverse drill hole 22.

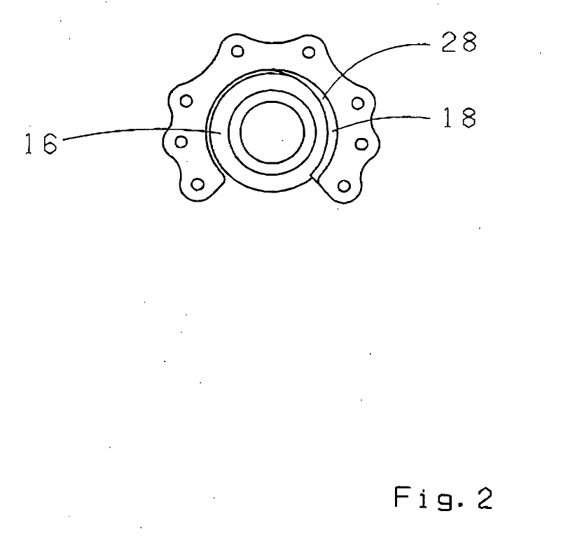

FIG. 2 shows a body with bearing 28 and an example of the holding plate 16 with a crescent-shaped recess 16.

Reference Numerals

2 automotive transmission
4 shaft
6 central drill hole
8 transverse drill hole
10 synchronization device
12 synchronizer body
14 drill hole
18 sickle-shaped recess
20 bearing
22 transverse drill hole
24 bearing surface
26 gear wheel
28 bearing

1-3. (canceled)

4. An oil supply device for an automotive transmission (2) having gear wheels arranged on shafts, with bearings in which the gear wheels and the shafts are rotationally positioned, and synchronizer mechanism devices (10) which are movable in a desired direction by operating a lever with control rods and a shift-fork,
the device comprising: a shaft (4) having an axially central drill hole (6) and at least one transverse drill hole (8), extending between the drill hole (6) to an exterior of the shaft (4) for supplying oil, a synchronizer body (12) of the synchronizer mechanism (10) having at least one drill hole (14), and a holding plate with a crescent-shaped recess (18) between a synchronizer mechanism (10) and a bearing (28).

5. The oil supply device according to claim 4, wherein the synchronizer body (12) is axially enclosed by a metal plate on a side facing away from a bearing (20).

6. The oil supply device according to claim 4, wherein the shaft (4) has at least one transverse drill hole (22) on a bearing surface (24) of the gear wheel (26).

7. An device for supplying oil within an automotive transmission (2), the transmission (2) having a plurality of gear wheels arranged on at least one shaft, the gear wheels being rotationally driven by the at least shaft, and a synchronizer mechanism (10) which is movable in a desired direction by operation of a lever with control rods and a shift fork, the device comprising:
a shaft (4) having an axially central bore and at least one radial drill hole extending radially from the axially central bore to an exterior surface of the shaft (4), and the at least one drill hole being transverse in relation to the axial central bore;
a synchronizer body (12) of the synchronizer mechanism (10) having at least one axially extending drill hole (14);
a holding plate (16) located between the synchronizer mechanism (10) and a bearing (28), and the holding plate (16) having a crescent shaped recess;
the synchronizer body (12) having a metal plate extending from an radially outside surface and being at a first end of the synchronizer body (12), the first end of the synchronizer body (12) being axially further from a bearing (20) than a second end of the synchronizer body (12);
the at least one radial drill hole (14) extends radially from the axially central bore to the exterior surface of the shaft (4) to a bearing surface (24) of one of the plurality of gear wheels; and
lubricating oil being radially transferred from the central bore (6), during rotation of the shaft (4), through the at least one radial drill hole to the at least one axially extending drill hole (14) of the synchronizer body (12) and the bearing surface (24) of one of the plurality of gear wheels to provide lubrication to the at least one synchronizer body (12) and the plurality of gear wheels.
